(19) United States
(12) Patent Application Publication
(10) Pub. No.: US 2026/0169624 A1
(43) Pub. Date: Jun. 18, 2026

(54) TOUCH INPUT APPARATUS

(71) Applicant: MITSUBISHI ELECTRIC CORPORATION, Tokyo (JP)

(72) Inventors: Daisuke MURAKAMI, Tokyo (JP); Takuma AOSHIMA, Tokyo (JP)

(21) Appl. No.: 19/124,832

(22) PCT Filed: Jan. 13, 2023
(86) PCT No.: PCT/JP2023/000870

§ 371 Date: Apr. 25, 2025

(51) Int. Cl. G06F 3/04886; F24H 9/20; F24H 9/28; F24H 15/395; F24H 15/45; G06F 3/041; G06F 3/04817; G06F 3/04895

(52) U.S. Cl. CPC G06F 3/04886; F24H 9/2007; F24H 9/28; F24H 15/395; F24H 15/45; G06F 3/0418; G06F 3/04817; G06F 3/04895; G06F 2203/04104

(57) ABSTRACT

A remote controller which is a touch input apparatus includes a touch panel unit including a plurality of keys, a display unit including a figure display unit that displays a figure corresponding to each of the plurality of keys, and a processing unit that determines whether or not key input is invalid in a case where any one of the plurality of keys is pressed and displays the figure corresponding to the pressed key in a display form different between a case where the key input is invalid and a case where the key input is valid.

### CROSS REFERENCE TO RELATED APPLICATION

This application is a U.S. national stage application of PCT/JP2023/000870 filed on Jan. 13, 2023, the contents of which are incorporated herein by reference.

### FIELD

The present disclosure relates to a touch input apparatus including a touch input device.

### BACKGROUND

In a case where a touch input device such as a touch panel includes a plurality of keys, there is a possibility that a user touches and presses a key different from an intended key.

However, the touch input device has no key stroke, and the user does not obtain click feeling. Therefore, it is difficult for the user of the touch input apparatus including the touch input device to recognize which key the user has actually pressed. Therefore, in the touch input apparatus, it is required to improve operability by making it easy to recognize which key the user has pressed.

Furthermore, when the user places one's hand on and leans on the touch input apparatus installed on a wall surface, the user may unintentionally press any one of the plurality of keys for a long time. Therefore, in a case where the press of the key that may be against the user's intention is detected, it is necessary to invalidate the press of the key without accepting the press of the key, to notify the user that the press of the key that may be against the user's intention has been performed, and to prompt the user whose key press has been invalidated to perform an operation again since there is a case where the user intentionally press the key.

Patent Literature 1 discloses a touch input apparatus that makes it easier for a user to recognize which key the user has pressed, by having a backlight function that causes a light emitting unit corresponding to a key pressed by the user to emit light. The user of the touch input apparatus disclosed in Patent Literature 1 can determine whether or not the press of the key has been accepted, based on whether or not the light emitting unit corresponding to the pressed key has emitted light.

### Patent Literature

Patent Literature 1: Japanese Patent Application Laid-open No. 2007-157157

However, the touch input apparatus disclosed in Patent Literature 1 needs a light emitting element that realizes the backlight function. Therefore, there is a problem in that the number of components increases.

### SUMMARY

The present disclosure has been made in view of the above, and an object of the present disclosure is to obtain a touch input apparatus that can cause a user to recognize which key has been pressed by the user and whether or not the press of the key has been accepted, without using a light emitting element that realizes a backlight function.

In order to solve the above-described problems and achieve the object, a touch input apparatus according to the present disclosure includes a touch panel unit including a plurality of keys, and a display unit including a figure display unit that displays a figure corresponding to each of the plurality of keys. The touch input apparatus includes a processing unit to determine whether or not key input is invalid in a case where any one of the plurality of keys is pressed, and display the figure corresponding to the pressed key in a display form different between a case where the key input is invalid and a case where the key input is valid.

A touch input apparatus according to the present disclosure achieves an effect that it is possible to cause a user to recognize which key the user has pressed and whether or not the press of the key has been accepted, without using a light emitting element that realizes a backlight function.

### BRIEF DESCRIPTION OF DRAWINGS

FIG. 1 is a diagram illustrating an appearance of a remote controller according to a first embodiment.

FIG. 2 is a functional block diagram of the remote controller according to the first embodiment.

FIG. 3 is a flowchart illustrating a flow of an operation of the remote controller according to the first embodiment.

FIG. 4 is a diagram illustrating an example of a state where two keys are simultaneously pressed in the remote controller according to the first embodiment.

FIG. 5 is a diagram illustrating an appearance of a remote controller according to a second embodiment.

FIG. 6 is a diagram illustrating an appearance of a remote controller according to a third embodiment.

FIG. 7 is a flowchart illustrating a flow of an operation of the remote controller according to the third embodiment.

FIG. 8 is a diagram illustrating an example of a hardware configuration of a processing unit of the remote controller according to any one of the first to third embodiments.

### DETAILED DESCRIPTION

Hereinafter, a touch input apparatus according to embodiments will be described in detail with reference to the drawings.

### First Embodiment

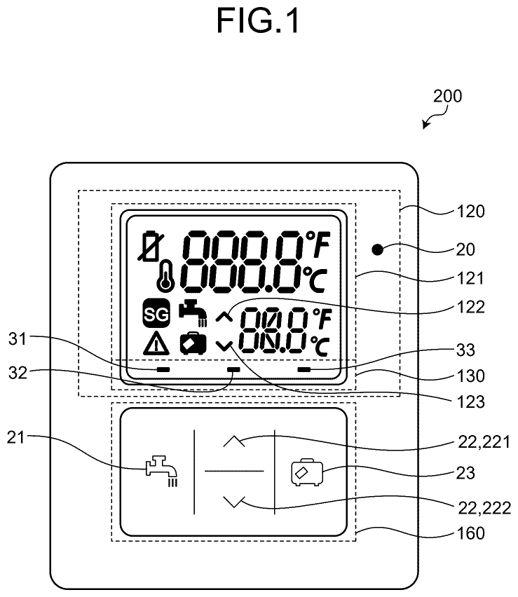

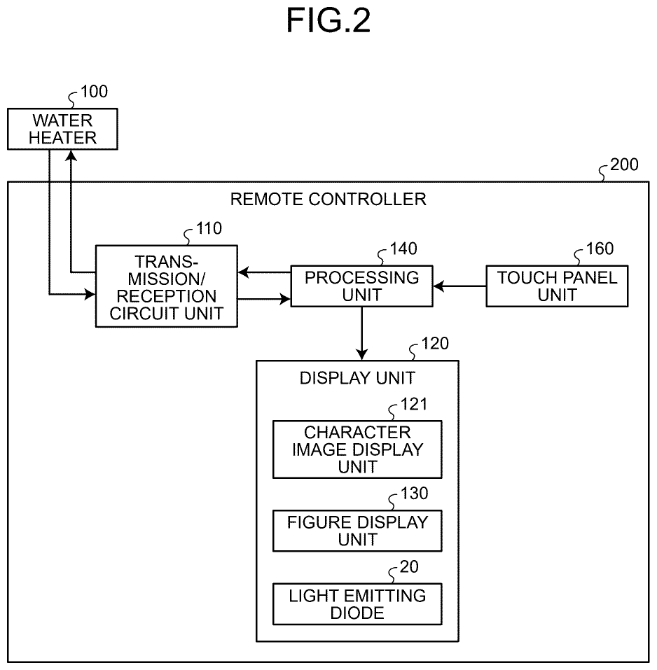

FIG. 1 is a diagram illustrating an appearance of a remote controller according to a first embodiment. FIG. 2 is a functional block diagram of the remote controller according to the first embodiment. A remote controller 200 that is a touch input apparatus according to the first embodiment is connected to a water heater 100. The remote controller 200 includes a transmission/reception circuit unit 110, a display unit 120, a processing unit 140, and a touch panel unit 160.

The transmission/reception circuit unit 110 is a communication interface for transmitting and receiving signals to and from the water heater 100.

In the touch panel unit 160, a hot water supply key 21 that switches on/off of a hot water supply operation, an up/down key 22 that changes a hot water set temperature, and a transition key 23 that transitions to an absent mode. The up/down key 22 includes an up key 221 that raises the hot water set temperature and a down key 222 that lowers the hot water set temperature. The up key 221 is a key that raises the hot water set temperature that is a set value, and the down key 222 is a key that lowers the hot water set temperature that is a set value.

The display unit 120 includes a character image display unit 121 that displays a character and an image and a light emitting diode 20 for anomaly display. The character image display unit 121 can be configured by using a liquid crystal panel or an organic electroluminescence panel. In the first embodiment, the display unit 120 is configured by using a liquid crystal panel of a monochrome thin film transistor that is highly visible liquid crystal. The character and the image displayed on the character image display unit 121 include an upward icon 122 and a downward icon 123. The upward icon 122 is an upward image. The downward icon 123 is a downward image.

A figure display unit 130 causes a user to recognize which key has been pressed, by displaying FIGS. 31, 32, and 33 respectively corresponding to the hot water supply key 21, the up/down key 22, and the transition key 23 on the touch panel unit 160. The FIGS. 31, 32, and 33 displayed on the figure display unit 130 can be displayed by at least one of lighting and blinking. The FIGS. 31, 32, and 33 displayed on the figure display unit 130 are at least any one of a bar, a circle, and a polygon. In the first embodiment, it is assumed that the FIGS. 31, 32, and 33 be bars. Since the FIG. 32 corresponds to both of the up key 221 and the down key 222, the number of FIGS. 31, 32, and 33 is less than the number of hot water supply key 21, up key 221, down key 222, and transition key 23.

The FIGS. 31, 32, and 33 are displayed at positions corresponding to the keys in the touch panel unit 160 in the figure display unit 130. The FIG. 31 corresponding to the hot water supply key 21 is displayed at a position immediately above the hot water supply key 21, in the figure display unit 130. Furthermore, the FIG. 32 corresponding to the up/down key 22 is displayed immediately above the up/down key 22, and the FIG. 33 corresponding to the transition key 23 to the absent mode is displayed immediately above the transition key 23.

The processing unit 140 can be configured using a microcontroller. Note that, for the processing unit 140, an external memory such as an electrically erasable programmable read-only memory may be provided.

The processing unit 140 detects an input signal of a key pressed by the user on the touch panel unit 160, and outputs information regarding the pressed key based on the input signal. As a result, the processing unit 140 sends a command to the water heater 100 through the transmission/reception circuit unit 110 and controls the water heater 100 so as to perform an operation corresponding to the key pressed in the touch panel unit 160.

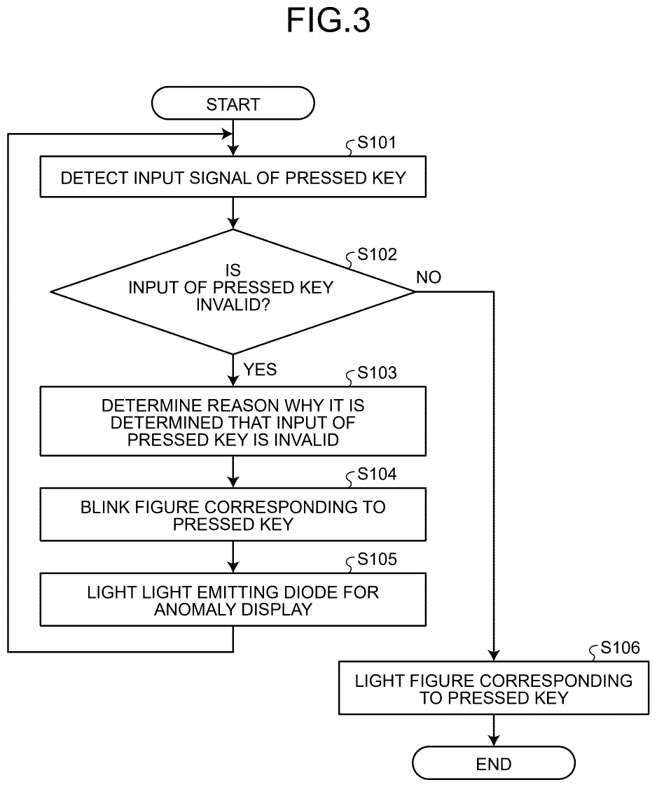

FIG. 3 is a flowchart illustrating a flow of an operation of the remote controller according to the first embodiment. In step S101, the processing unit 140 detects an input signal of a key pressed by the user. In step S102, the processing unit 140 determines whether or not an input of the pressed key is invalid. Valid input of the pressed key indicates that any one of the hot water supply key 21, the up key 221, the down key 222, and the transition key 23 is pressed for a time period shorter than a preset time period. For example, in a case where a user who intends to press a key touches a key different from the intended key, the plurality of keys are simultaneously pressed. However, it is difficult for the processing unit 140 to accurately determine which key the user has intended to press. Furthermore, in a case where the user leans on a wall surface where the remote controller 200 is installed as touching one's hand on the wall surface, there is a possibility that any one of the keys is pressed for a long time. Therefore, in the first embodiment, in a case of simultaneously pressing that is a case where the plurality of keys are simultaneously pressed or in a case where any one of the keys is pressed for a long time, it is assumed that the processing unit 140 determine that the input of the pressed key is invalid.

If the input of the pressed key is invalid, Yes is selected in step S102, and the processing unit 140 determines in step S103 a reason why the processing unit 140 has determined that the input of the pressed key is invalid. Here, the processing unit 140 determines whether the input is invalid because the plurality of keys are simultaneously pressed or whether the input is invalid because the key is pressed for a long time. By determining the reason why the processing unit 140 has determined that the input of the pressed key is invalid, the processing unit 140 specifies whether or not there is a plurality of keys of which the input becomes invalid.

In step S104, the processing unit 140 blinks a figure corresponding to the pressed key. For example, in a case where the input becomes invalid because the hot water supply key 21 is pressed for a long time, the FIG. 31 corresponding to the hot water supply key 21 is blinked. Furthermore, in a case where the hot water supply key 21 and the down key 222 are simultaneously pressed, the FIG. 31 corresponding to the hot water supply key 21 and the FIG. 32 corresponding to the up/down key 22 are blinked. In step S105, the processing unit 140 lights the light emitting diode 20 for anomaly display. After step S105, the processing returns to step S101.

On the other hand, if the input of the pressed key is valid, No is selected in step S102, and the processing unit 140 lights the figure corresponding to the pressed key in step S106, and thereafter, the processing unit 140 ends the processing.

In this way, in the remote controller 200 according to the first embodiment, the hot water supply key 21, the up/down key 22, and the transition key 23 on the touch panel unit 160 and the FIGS. 31, 32, and 33 corresponding to the hot water supply key 21, the up/down key 22, and the transition key 23 on the figure display unit 130 are respectively disposed in a line in the vertical direction. Therefore, by lighting the FIGS. 31, 32, and 33 corresponding to the pressed key, the user can recognize the press of which key has been accepted.

Furthermore, in a case where the input of the pressed key is invalid, the processing unit 140 blinks the FIGS. 31, 32, and 33 corresponding to the input key in accordance with a reason why the processing unit 140 has determined that the input of the key is invalid, displays the FIGS. 31, 32, and 33 on the figure display unit 130, and lights the light emitting diode 20. Therefore, in a case where any one of the keys is pressed for a long time, the remote controller 200 according to the first embodiment can notify the user that the key is pressed longer than necessary, and it is possible to cause the user to recognize that it is not necessary to press the key for a long time. Note that a time required to determine long press of the key can be changed by the user by setting. Furthermore, in a case where two or more keys are simultaneously pressed, the remote controller 200 according to the first embodiment can alert the user not to simultaneously press the plurality of keys.

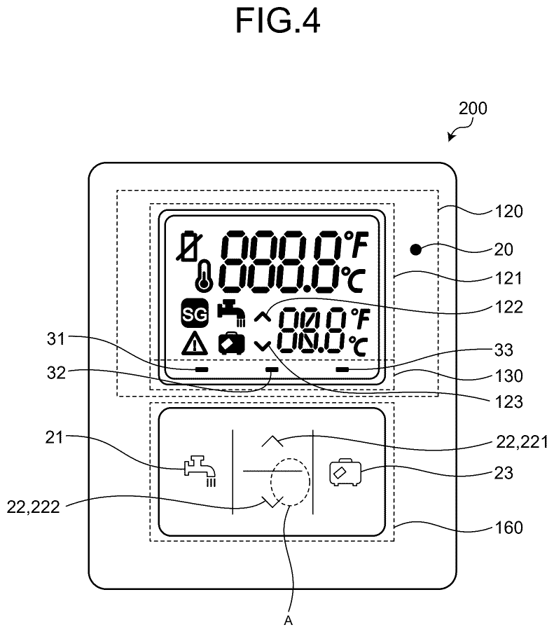

Note that, in a case where two or more keys are simultaneously pressed, if an area where a finger is touched differs for each key, the processing unit 140 may determine that a key having a larger area where the finger is touched has been pressed. FIG. 4 is a diagram illustrating an example of a state where two keys are simultaneously pressed in the remote controller according to the first embodiment. In FIG. 4, a region A indicates a portion where a finger of the user is touched. In the example illustrated in FIG. 4, since the down key 222 has a larger area where the finger of the user is touched than the up key 221, the processing unit 140 determines that the down key 222 has been pressed. The processing unit 140 determines that the key having a larger area where the finger is touched has been pressed so that the input is less likely to be invalid, and operability is improved, even if the user presses the key in a portion close to a boundary between the plurality of keys.

Regarding the up/down key 22 used to change the hot water set temperature, the user cannot recognize which one of the keys for raising or lowering the temperature is pressed only by displaying the FIG. 32 on the figure display unit 130. Therefore, the character image display unit 121 may light the upward icon 122 or the downward icon 123 simultaneously with the FIG. 32.

As described above, the remote controller 200 according to the first embodiment can cause the user to recognize which key has been pressed by the user and whether or not the press of the key has been accepted, without using the light emitting element that realizes the backlight function.

### Second Embodiment

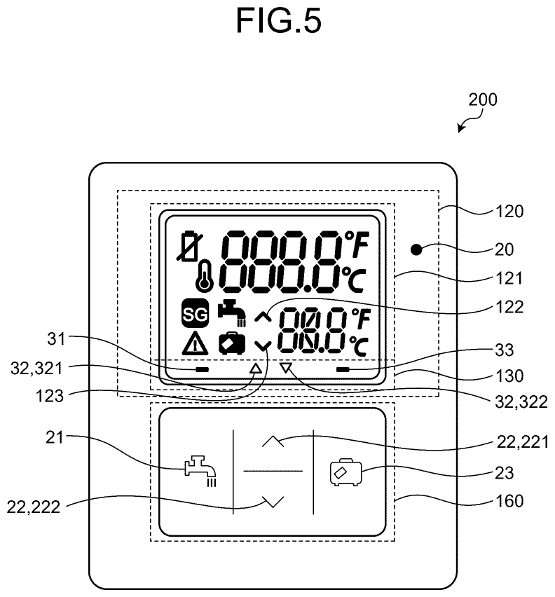

FIG. 5 is a diagram illustrating an appearance of a remote controller according to a second embodiment. In the remote controller 200 that is a touch input apparatus according to the second embodiment, the FIG. 32 corresponding to the up/down key 22 includes an upward triangle 321 and a downward triangle 322. That is, in the remote controller 200 according to the second embodiment, the FIG. 32 includes the upward triangle 321 corresponding to the up key 221 and the downward triangle 322 corresponding to the down key 222. Therefore, in the remote controller 200 according to the second embodiment, the number of the FIGS. 31 and 33, the upward triangle 321, and the downward triangle 322 is the same as the number of the hot water supply key 21, the up key 221, the down key 222, and the transition key 23, and the FIGS. 31 and 33, the upward triangle 321, and the downward triangle 322 correspond to the hot water supply key 21, the transition key 23, the up key 221, and the down key 222 in one-to-one correspondence. The other configurations are similar to those of the remote controller 200 according to the first embodiment.

The processing unit 140 lights the upward triangle 321 when the up key 221 is pressed and lights the downward triangle 322 when the down key 222 is pressed. Furthermore, in a case where the up key 221 is pressed for a long time or in a case where the plurality of keys including the up key 221 are simultaneously pressed, the processing unit 140 blinks the upward triangle 321. Furthermore, in a case where the down key 222 is pressed for a long time or in a case where the plurality of keys including the down key 222 are simultaneously pressed, the processing unit 140 blinks the downward triangle 322.

The remote controller 200 according to the second embodiment can cause the user to recognize which one of the up key 221 and the down key 222 is pressed by distinguishing between the up key 221 and the down key 222 and whether or not the press of the key has been accepted, without using the light emitting element that realizes the backlight function.

### Third Embodiment

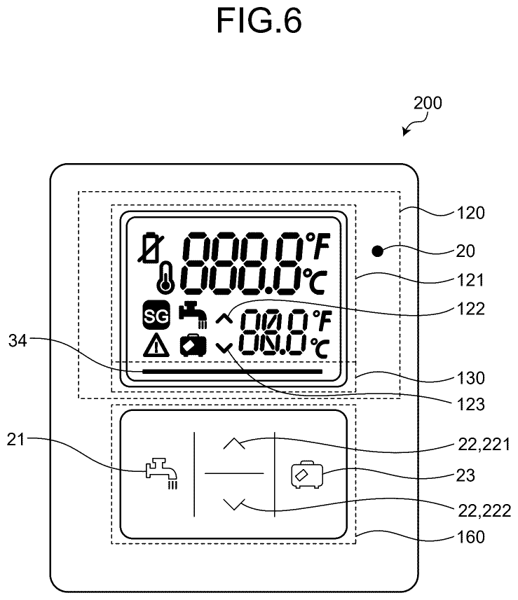

FIG. 6 is a diagram illustrating an appearance of a remote controller according to a third embodiment. In the remote controller 200 that is a touch input apparatus according to the third embodiment, a one-segment bar 34 is displayed in the figure display unit 130. The one-segment bar 34 is displayed across an upper portion of the hot water supply key 21, an upper portion of the up/down key 22, and an upper portion of the transition key 23, in the figure display unit 130. The one-segment bar 34 corresponds to all of the hot water supply key 21, the up/down key 22, and the transition key 23. In the remote controller 200 according to the third embodiment, the number of one-segment bars 34 that are the figures displayed in the figure display unit 130 is less than the total number of the hot water supply key 21, the up key 221, the down key 222, and the transition key 23.

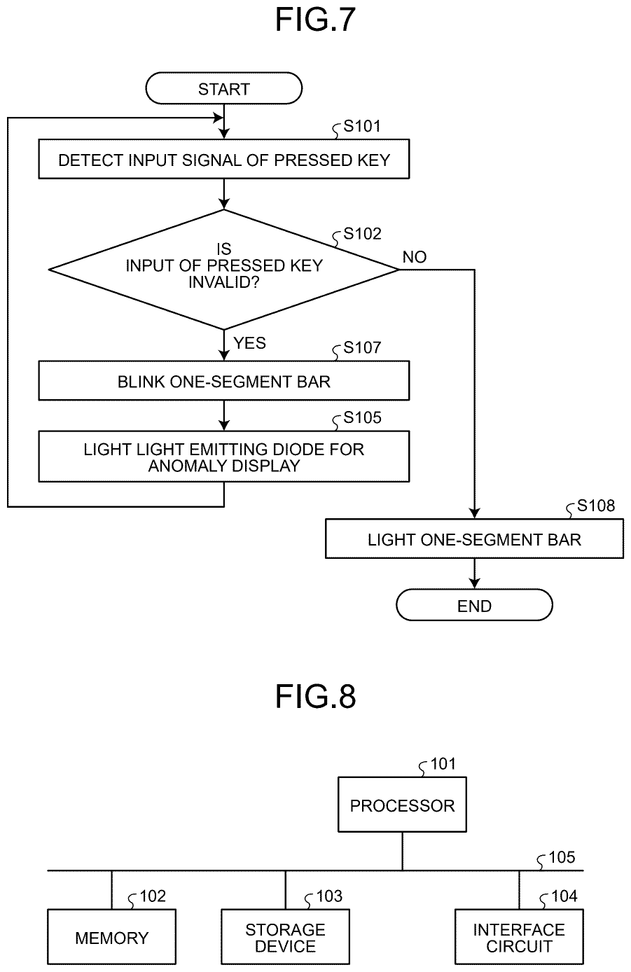

FIG. 7 is a flowchart illustrating a flow of an operation of the remote controller according to the third embodiment. The operations in steps S101 and S102 are similar to the operation of the remote controller 200 according to the first embodiment.

If the input of the pressed key is invalid, Yes is selected in step S102, and the processing unit 140 blinks the one-segment bar 34 in step S107. Step S105 is similar to the operation of the remote controller 200 according to the first embodiment.

On the other hand, if the input of the pressed key is valid, No is selected in step S102, and the processing unit 140 lights the one-segment bar 34 in step S108, and thereafter, ends the processing.

In this way, in the remote controller 200 according to the third embodiment, if the input of any one of the hot water supply key 21, the up/down key 22, and the transition key 23 is valid, the processing unit 140 lights the one-segment bar 34. On the other hand, if the input of any one of the hot water supply key 21, the up/down key 22, and the transition key 23 is invalid, the processing unit 140 blinks the one-segment bar 34 and lights the light emitting diode 20 for anomaly display.

The remote controller 200 according to the third embodiment does not distinguish each of the hot water supply key 21, the up/down key 22, and the transition key 23.

However, since the remote controller 200 can cause the user to recognize whether or not key input is valid or invalid, the operability is improved.

In the remote controller 200 according to the third embodiment, since only the one-segment bar 34 is displayed in the figure display unit 130, processing for selecting the figure in the figure display unit 130 in accordance with the type of the pressed key is unnecessary, and a processing load of the processing unit 140 can be reduced. Therefore, as compared with the remote controller 200 according to the first embodiment, an arithmetic device with a lower processing capability can be used for the processing unit 140.

FIG. 8 is a diagram illustrating an example of a hardware configuration of the processing unit of the remote controller according to any one of the first to third embodiments. As illustrated in FIG. 8, the processing unit 140 includes a processor 101, a memory 102, a storage device 103, and an interface circuit 104. The processor 101, the memory 102, the storage device 103, and the interface circuit 104 can transmit and receive data to and from each other via a bus 105.

The processor 101 executes functions of the processing unit 140, by reading and executing a processing program stored in the storage device 103. Note that a part or all of the processing unit 140 can be configured by hardware represented by an application specific integrated circuit (ASIC) and a field programmable gate array (FPGA). That is, a processing circuitry that implements a part or all of the processing unit 140 may be dedicated hardware.

Furthermore, the processor 101 can read a processing program from one or more of storage media including a magnetic disk, a universal serial bus (USB) memory, an optical disk, a compact disk, and a digital versatile disc (DVD) via an interface (not illustrated) and store the processing program in the storage device 103 to execute the processing program.

The configurations described in the above embodiments indicate an example of content and can be combined with other known techniques. Furthermore, the configurations described in the embodiments can be partially omitted or changed without departing from the scope of the invention.

1. A touch input apparatus comprising:
touch panel circuitry including a plurality of keys corresponding to operation types different from each other;
display including a figure display that displays a figure corresponding to each of the plurality of keys; and
processing circuitry to determine whether or not key input is invalid in a case where any one of the plurality of keys is pressed, and display the figure corresponding to the pressed key in a display form different between a case where the key input is invalid and a case where the key input is valid, wherein
the figure display is disposed above and adjacent to the touch panel circuitry,
the plurality of keys are disposed in a left-right direction, and
the figure corresponding to each of the plurality of keys is disposed above each of the plurality of keys.

2. (canceled)

3. The touch input apparatus according to claim 1, wherein
the plurality of keys include a key that increases a set value and a key that decreases the set value, and
the figure corresponding to the key that increases the set value is a figure that faces upward, and the figure corresponding to the key that decreases the set value is a figure that faces downward.

4. The touch input apparatus according to claim 1, wherein
the plurality of keys include a key that increases a set value and a key that decreases the set value,
the display includes a character image display that displays a character and an image, and
in a case where the key that increases the set value is pressed, the processing circuitry displays an image corresponding to the key that increases the set value in the character image display, and in a case where the key that decreases the set value is pressed, the processing circuitry displays an image corresponding to the key that decreases the set value in the character image display.

5. The touch input apparatus according to claim 1, wherein the number of the figures is less than the number of the plurality of keys, and two or more of the plurality of keys are associated with at least one of the figures.

6. The touch input apparatus according to claim 1, wherein one of a display form in a case where the key input is invalid and a display form in a case where the key input is valid is lighting, and another one is blinking.

7. The touch input apparatus according to claim 1, wherein in a case where at least any one of the plurality of keys is pressed for a long time, the processing circuitry determines that the key input is invalid.

8. The touch input apparatus according to claim 1, wherein in a case where two or more of the plurality of keys are simultaneously pressed, the processing circuitry determines that the key input is invalid.

9. The touch input apparatus according to claim 1, wherein
the display includes a light emitting diode for anomaly display, and
in a case where the key input is invalid, the processing circuitry lights the light emitting diode.

10. The touch input apparatus according to claim 1, wherein the plurality of keys are keys corresponding to operation types related to a hot water supply operation.

11. The touch input apparatus according to claim 1, provided in a remote controller connected to a water heater.
